(19) United States
(12) Patent Application Publication
(10) Pub. No.: US 2024/0399680 A1
(43) Pub. Date: Dec. 5, 2024

(54) LINER REPLACING DEVICE

(71) Applicants: Murata Machinery, Ltd., Kyoto-shi (JP); Toyota Jidosha Kabushiki Kaisha, Toyota-shi (JP)

(72) Inventors: Motohiro Tanigawa, Kyoto-shi (JP); Masatsugu Goyude, Kyoto-shi (JP); Toshihiro Matsui, Kyoto-shi (JP); Hirotaka Wada, Kyoto-shi (JP); Yoshihiro Kino, Kyoto-shi (JP); Hidehiro Takeoka, Kyoto-shi (JP); Yasuhiro Sakanashi, Kyoto-shi (JP); Dai Shimizube, Kyoto-shi (JP); Daigoro Nakamura, Kyoto-shi (JP); Yoshinori Miura, Toyota-shi (JP)

(73) Assignees: Murata Machinery, Ltd., Kyoto-shi (JP); Toyota Jidosha Kabushiki Kaisha, Toyota-shi (JP)

(21) Appl. No.: 18/676,920

(22) Filed: May 29, 2024

(30) Foreign Application Priority Data
May 30, 2023 (JP) 2023-088627

(51) Int. Cl. B29C 70/54; B29C 70/32; F17C 1/00

(52) U.S. Cl. CPC B29C 70/54; B29C 70/32; F17C 1/00; F17C 2201/0109; F17C 2203/0604; F17C 2203/0673; F17C 2209/2154; F17C 2209/232

(57) ABSTRACT

Time required for replacing a liner is shortened. A liner replacing device is configured to replace a liner for a supporting unit. The liner replacing device includes paired gripping jigs. The paired gripping jigs are aligned in a front-rear direction and are able to move toward and away from the supporting unit in the left-right direction. Each of the gripping jigs includes a first clamp configured to grip a winding-completed liner on which a fiber bundle is wound and a second clamp configured to grip a new liner on which no fiber bundle has been wound.

### CROSS-REFERENCE TO RELATED APPLICATION

This application claims the benefit of Japanese Pat. App. No. 2023-088627, filed on May 30, 2023, which application is incorporated herein by reference in its entirety.

### TECHNICAL FIELD

This disclosure relates to a liner replacing device configured to wind a fiber bundle onto a liner in a filament winding device.

### BACKGROUND

The filament winding device described in Japanese Patent No. 6780770 is provided with a liner replacing device which is configured to replace a liner (hereinafter, a winding-completed liner) onto which a fiber bundle is wound with a new liner. More specifically, the liner replacing device has a carrying-in carrier and a carrying-out carrier. The carrying-out carrier moves the winding-completed liner, which has been detached from a supporting unit supporting the liner, to a predetermined placement table. After the winding-completed liner is moved to the placement table, the carrying-in carrier catches a new liner placed on the placement table and transports the liner to the vicinity of the supporting unit.

As described above, the above-mentioned liner replacing device starts the movement of the new liner after the movement of the winding-completed liner has been completed. The replacement of the liner therefore takes time.

It could therefore be helpful to shorten the time required for replacing a liner.

### SUMMARY

### We Thus Provide:

According to a first aspect, a liner replacing device is configured to replace a liner for a supporter that supports the liner in a filament winding device that winds a fiber bundle onto the liner, the liner replacing device including paired gripping jigs which are aligned in a predetermined liner axial direction having a horizontal component and are configured to move toward and away from the supporter in a predetermined direction orthogonal to both the liner axial direction and an up-down direction, each of the paired gripping jigs including: a first clamp configured to grip a first liner that is the liner and on which the fiber bundle is wound; and a second clamp configured to grip a second liner that is the liner and on which the fiber bundle has not been wound.

The first liner and the second liner can be simultaneously held by the paired gripping jigs. On this account, the first liner and the second liner can be moved simultaneously according to need. The time required for replacing the liner can therefore be shortened.

According to a second aspect, the liner replacing device of the first aspect further includes a rotational drive unit which is configured to rotationally drive the paired gripping jigs about a rotation shaft extending in the liner axial direction.

When the paired gripping jigs can only move in a parallel manner, a wide moving space is required to prevent the liner from interfering with nearby members, when the liner is gripped and moved. Our liner can be moved in a relatively narrow moving space, because the paired gripping jigs are rotatable.

According to a third aspect, the liner replacing device of the second aspect is arranged so that, when viewed in the liner axial direction, an angle between a first virtual line segment and a second virtual line segment is smaller than 180 degrees, the first virtual line segment connecting the center point of the rotation shaft and the center point of the first liner when the first liner is gripped by the first clamp, and the second virtual line segment connecting the center point of the rotation shaft and the center point of the second liner when the second liner is gripped by the second clamp.

It is thus possible to minimize the distance between the two liners that are simultaneously gripped by the liner replacing device. With this arrangement, the moving distance of the second liner is minimized when the first liner is detached from the supporting unit and a new liner is attached to the supporter. The time required for replacing the liner can therefore be shortened.

According to a fourth aspect, the liner replacing device of the second or third aspect further includes a control unit, the control unit controlling the rotational drive unit to position the first clamp gripping the first liner to be always below the second clamp gripping the second liner.

It is thus possible to maximally avoid the necessity of lifting of the first liner, which has been increased in weight due to the fiber bundle wound thereon, to a high position against gravity. The load on the rotational drive unit can therefore be reduced.

According to a fifth aspect, the liner replacing device of the second aspect further includes: a movement drive unit which is configured to move the paired gripping jigs in the predetermined direction; and a control unit, the control unit controlling the rotational drive unit to rotate the paired gripping jigs, while moving the paired gripping jigs in the predetermined direction by controlling the movement drive unit.

The time required for replacing the liner can thus be shortened compared to when the parallel movement and the rotation of the paired gripping jigs are performed at different timings.

### BRIEF DESCRIPTION OF THE DRAWINGS

FIG. 1 is a perspective view showing a filament winding device related to an example of the liner replacing device described herein.

FIG. 2 is a block diagram showing an electrical structure of the filament winding device.

FIG. 3 (a) and FIG. 3 (b) are front elevations of a helical winding unit.

FIG. 4 is a plan view of the filament winding device including a liner replacing device.

FIG. 5 is a front view of a liner elevation device and the liner replacing device.

FIG. 6 is a block diagram showing a detailed electrical structure of the filament winding device.

FIG. 7 is a plan view of the liner replacing device.

FIG. 8 is a plan view of the liner replacing device.

FIG. 9 shows how the liner replacing device operates.

FIG. 10 shows how the liner replacing device operates.

FIG. 11 shows how the liner replacing device operates.

FIG. 12 shows how the liner replacing device operates.

### DETAILED DESCRIPTION

### Filament Winding Device

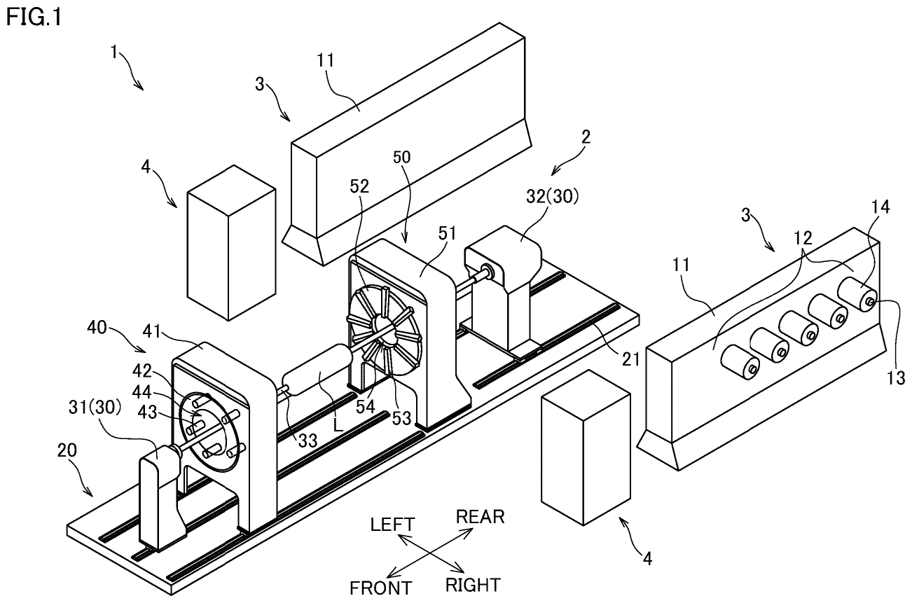

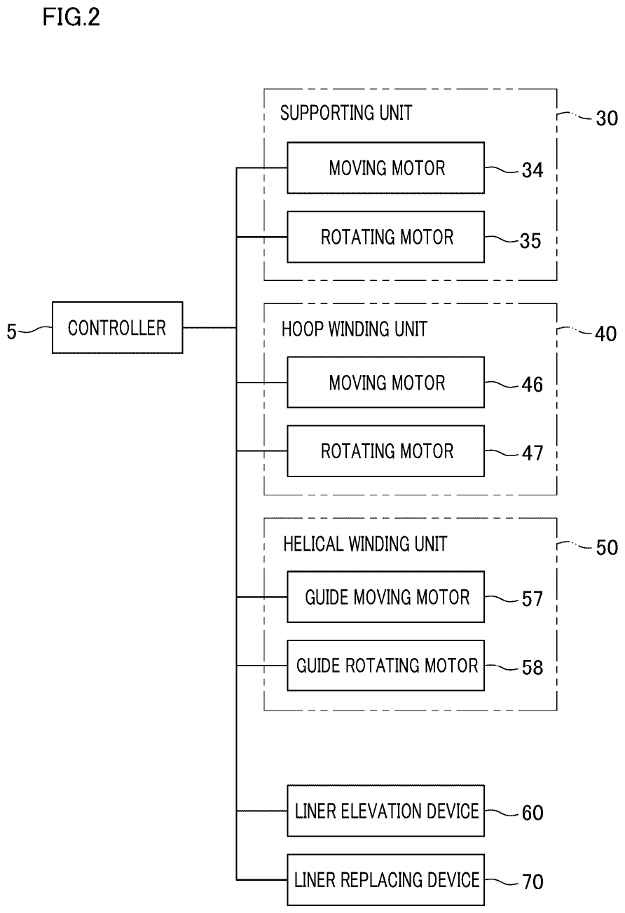

The following will describe an example of the liner replacing device described herein. FIG. 1 is a perspective view showing a filament winding device 1 related to this example. FIG. 2 is a block diagram of an electric configuration of the filament winding device 1. For convenience of explanation, the directions (front-rear direction and left-right direction) shown in FIG. 1 are defined below. The front-rear direction and the left-right direction are directions parallel to the horizontal direction. The front-rear direction and the left-right direction are orthogonal to each other. Furthermore, the direction orthogonal to both the front-rear direction and the left-right direction is defined as an up-down direction. In this regard, the up-down direction is a vertical direction in which gravity acts.

A filament winding device 1 is of a multiple-filaments feeding type, by which plural fiber bundles (not illustrated in FIG. 1) are simultaneously wound onto a liner L. The filament winding device 1 includes a winder 2, creel stands 3, and pretreatment units 4. On the whole, the filament winding device 1 is arranged to be substantially symmetrical in the left-right direction. The winder 2 winds fiber bundles onto a cylindrical liner L. Each fiber bundle is formed by, for example, impregnating a thermosetting or thermoplastic synthetic resin material into a fiber material such as carbon fiber. The shape of the liner L may vary depending on the final product. For example, when the final product is a pressure tank, the liner L having dome portions at both ends of a cylindrical portion as shown in FIG. 1 is used. The materials of the liner L include high-strength aluminum, metal, and resin. After the fiber bundles are wound onto the liner L, a thermosetting process such as baking or a cooling process is performed. As a result, a final product such as a high-strength pressure tank is produced.

The creel stands 3 are positioned on the both sides in the left-right direction of the winder 2, for example. The creel stands 3 are positioned, for example, in the vicinity of a rear end portion of the winder 2 in the front-rear direction. Each creel stand 3 has, for example, a substantially rectangular parallelepiped frame 11 that extends in the front-rear direction. The frame 11 is provided with, for example, one or more bobbin holder group 12. The bobbin holder group 12 is provided to correspond to each of nozzle units 53 of a later-described helical winding unit 50, for example. Each bobbin holder group 12 has a plurality of (five in the present example) bobbin holders 13 aligned in, for example, the front-rear direction. Each bobbin holder 13 has an axis that extends in the left-right direction, for example. Each bobbin holder 13 supports a bobbin 14 on which a fiber bundle is wound, in a rotatable manner. In this example, nine bobbin holder groups 12 are provided, and five bobbins 14 are attached to each bobbin holder group 12. (Therefore 45 bobbins 14 are provided in total.) From the five bobbins 14 belonging to each bobbin holder group 12, five fiber bundles are supplied together. The fiber bundles supplied from the creel stand 3 are wound onto the liner L by the helical winding unit 50. While FIG. 1 shows two creel stands 3, the number of the creel stands 3 is not limited to this. In addition, to avoid complication of the drawing, only one of the plural bobbin holder groups 12 is shown in FIG. 1.

The pretreatment units 4 are configured to perform a predetermined pretreatment (e.g., application of a tension) for the fiber bundles. The pretreatment units 4 are, for example, provided between the corresponding creel stands 3 and the helical winding unit 50 (described later) in the running direction of the fiber bundles.

### Winder

The following will describe a more specific arrangement of the winder 2. The winder 2 includes a base 20, supporting units 30 (a first supporting unit 31 and a second supporting unit 32), a hoop winding unit 40, and a helical winding unit 50.

The base 20 supports the supporting units 30, the hoop winding unit 40, and the helical winding unit 50. On the top surface of the base 20, rails 21 are provided to extend in the front-rear direction. The supporting units 30 and the hoop winding unit 40 are movable in the front-rear direction along the rails 21. On the other hand, the helical winding unit 50 is fixed in position relative to the base 20, for example. The first supporting unit 31, the hoop winding unit 40, the helical winding unit 50, and the second supporting unit 32 are provided in this order from the front side to the rear side.

The supporting units 30 include the first supporting unit 31 and the second supporting unit 32. The first supporting unit 31 is positioned forward of the hoop winding unit 40. The second supporting unit 32 is positioned rearward of the helical winding unit 50. Through a supporting shaft 33 which extends in the axial direction of the liner L (i.e., in the front-rear direction), the supporting units 30 support the liner L so that the liner Lis rotatable about the shaft. The supporting units 30 include a moving motor 34 and a rotating motor 35 (see FIG. 2). The moving motor 34 moves the supporting units 30 (the first supporting unit 31 and the second supporting unit 32) in the front-rear direction along the rails 21. The rotating motor 35 rotates the supporting shaft 33 so that the liner L is rotated about the shaft. The operations of the moving motor 34 and the rotating motor 35 are controlled by a controller 5.

The hoop winding unit 40 is configured to perform hoop-winding onto the circumferential surface of the liner L. The hoop winding is a way of winding the fiber bundles onto the liner L in a direction substantially orthogonal to the axial direction of the liner L. The hoop winding unit 40 includes, for example, a main body 41, a rotation member 42, and plural (five in the present example) bobbin holders 43. The main body 41 is movable in the front-rear direction along the rails 21. The rotation member 42 is an annular member with a passing hole 44 formed to allow the liner L to pass through. The rotation member 42 is supported by the main body 41 to be rotatable about the axis of the liner L. The bobbin holders 43 are attached to the rotation member 42 at regular intervals in the circumferential direction. Each bobbin holder 43 has a rotation shaft extending in the front-rear direction and supports a bobbin (not illustrated) on which a fiber bundle is wound, in a rotatable manner.

The hoop winding unit 40 includes a moving motor 46 and a rotating motor 47 (see FIG. 2). The moving motor 46 moves the main body 41 in the front-rear direction along the rails 21. The rotating motor 47 rotates the rotation member 42 about the axis of the liner L. The operations of the moving motor 46 and the rotating motor 47 are controlled by the controller 5. When the hoop-winding is performed, the controller 5 rotates the rotation member 42 while causing the main body 41 to reciprocate along the rails 21. Because of this, the fiber bundles are taken out from the respective bobbins rotating around the liner L, and are simultaneously hoop-wound onto the circumferential surface of the liner L.

The helical winding unit 50 is configured to perform helical-winding onto the circumferential surface of the liner L. The helical winding is a way of winding the fiber bundles onto the liner L in a direction substantially parallel to the axial direction of the liner L. The helical winding unit 50 includes, for example, a main body 51, a frame member 52, and plural (nine in the present example) nozzle units 53. The main body 51 is fixed to the base 20, for example. The frame member 52 is an annular member with a passing hole 54 formed to allow the liner L to pass through. The frame member 52 is supported by the main body 51. The nozzle units 53 are radially arranged around the axis of liner L. Each nozzle unit 53 is attached to the frame member 52.

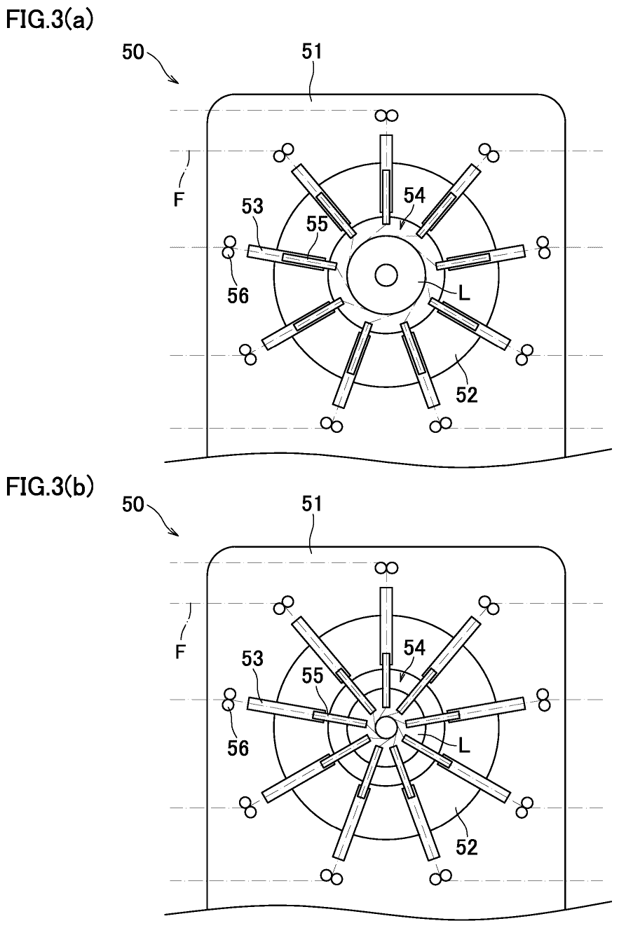

FIG. 3 (a) and FIG. 3 (b) are front elevations of the helical winding unit 50. To be more specific, FIG. 3 (a) shows a situation when fiber bundles F are wound onto the cylindrical portion of the liner L. FIG. 3 (b) shows a situation when fiber bundles F are wound onto the dome portion of the liner L. The nozzle unit 53 includes a guide member 55 guiding the fiber bundle F to the liner L. The guide member 55 extends in a radial direction of the liner L (hereinafter, this direction is simply referred to as the radial direction), and is configured to be movable in the radial direction and to be rotatable about a rotational axis extending in the radial direction. Radially outside each nozzle unit 53, a guide roller 56 is provided. The five fiber bundles F taken out from each bobbin holder group 12 of the creel stand 3 are introduced into one of the guide members 55 via the guide roller 56, and then supplied to the liner L from the leading end of the guide member 55.

The helical winding unit 50 includes a guide moving motor 57 and a guide rotating motor 58 (see FIG. 2). The guide moving motor 57 moves the guide members 55 simultaneously in the radial directions. The guide rotating motor 58 rotates the guide members 55 simultaneously about the rotational axis. The operations of the guide moving motor 57 and the guide rotating motor 58 are controlled by the controller 5. When the helical winding is performed, the controller 5 causes the liner L to pass through the passing hole 54 while slowly rotating the liner L about the axis. At the same time, the controller 5 suitably moves the guide member 55 of each nozzle unit 53 in the radial direction while rotating the guide member 55 of each nozzle unit 53 about the rotational axis. As a result, five fiber bundles F are properly pulled out from the leading end of the guide member 55 of each nozzle unit 53, and 45 fiber bundles F in total are simultaneously helical-wound onto the circumferential surface of the liner L.

### Further Description of Arrangement

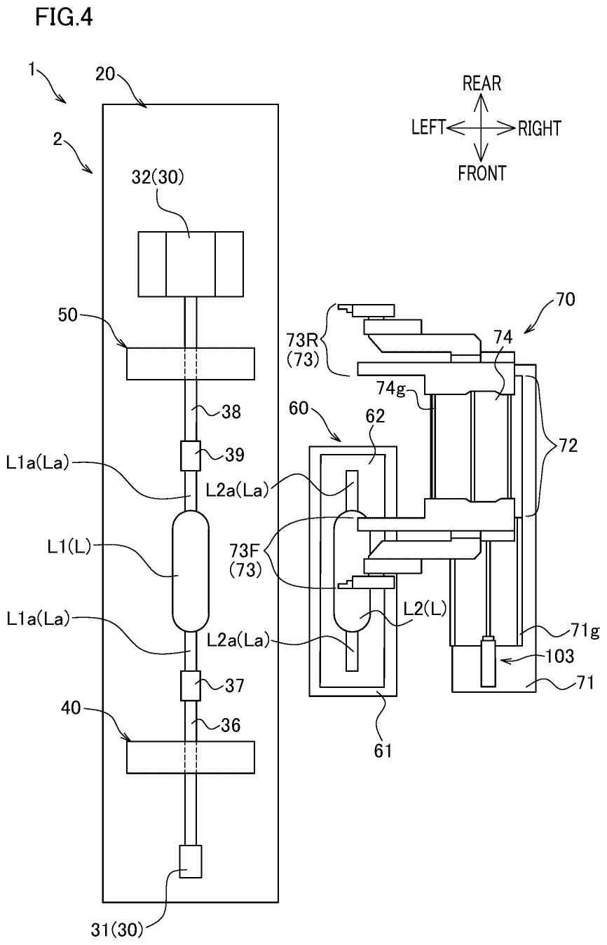

The following will further describe the configuration of filament winding device 1 with reference to FIG. 2 and FIG. 4. FIG. 4 is a plan view of the filament winding device 1 including a liner replacing device 70 (described later). As shown in FIG. 2 and FIG. 4, the filament winding device 1 includes, for example, a liner elevation device 60 and a liner replacing device 70. The liner elevation device 60 and the liner replacing device 70 are configured to replace a liner L supported by the supporting unit 30 with another liner L.

The liner elevation device 60 is provided so that, for example, a single liner L is temporarily placed thereon. On the liner elevation device 60, it is possible to place either a liner L on which a fiber bundle F has already been wound (hereinafter, a winding-completed liner L1) or a liner L on which a fiber bundle F has not been wound yet (hereinafter, a new liner L2). The winding-completed liner L1 corresponds to a first liner. The new liner L2 corresponds to a second liner. The new liner L2, for example, is placed on the liner elevation device 60 by an operator. The winding-completed liner L1 is placed on the liner elevation device 60 by the liner replacing device 70.

The liner replacing device 70 is configured to replace a winding-completed liner L1 supported by supporting unit 30 with a new liner L2. The liner replacing device 70 has, for example, a base portion 71, a front-rear movement portion 72, and paired arm portions 73 (arm portions 73F and 73R). The base portion 71 is a portion which fixes the installation location of the liner replacing device 70. The front-rear movement portion 72 is configured to be movable on the base portion 71 in the front-rear direction, for example. The paired arm portions 73 are attached to the front-rear movement portion 72, and are configured to be able to grip a liner L. The paired arm portions 73 can receive a new liner L2 from the liner elevation device 60 and move the new liner L2 to the close vicinity of the supporting unit 30 (supporter). Furthermore, the paired arm portions 73 can grip a winding-completed liner L1 detached from the supporting unit 30 and place the winding-completed liner L1 on the liner elevation device 60.

The following will describe a further detailed example of the liner L with reference to FIG. 4. The liner L has a pair of shafts La formed at end portions in the axial direction of the liner L, respectively. For example, a winding-completed liner L1 has a pair of shafts L1a, and a new liner L2 has a pair of shafts L2a. When the axial direction of liner L is arranged to be along the front-rear direction (a liner axial direction), the front shaft La is supported by the first supporting unit 31 whereas the rear shaft La is supported by the second supporting unit 32.

The following will describe a further detailed example of the supporting unit 30 with reference to FIG. 4. The first supporting unit 31 includes, for example, a supporting shaft 36 extending in the front-rear direction and a chucking portion 37 provided at a rear end portion of the supporting shaft 36 (see FIG. 4). The chucking portion 37 is configured to hold the shaft La provided at a front end portion of the liner L. The second supporting unit 32 includes, for example, a supporting shaft 38 extending in the front-rear direction and a chucking portion 39 provided at a front end portion of the supporting shaft 38. The chucking portion 39 is configured to be able to hold the shaft La provided at the rear end portion of the liner L. When the holding of the paired shafts La of the liner L by the chucking portions 37 and 39 is released, the liner replacing device 70 becomes capable of moving the liner L. When the paired shafts La of the liner L gripped by the liner replacing device 70 are held by the chucking portions 37 and 39, it becomes possible to cancel the gripping of the liner L by the liner replacing device 70.

In a known process in which the liner replacing device 70 starts movement of a new liner L2 after completion of movement of a winding-completed liner L1, the replacement of the liner L takes time. Therefore, to shorten the time needed for replacing the liner L, the filament winding device 1 is configured, for example, as follows.

### Liner Elevation Device

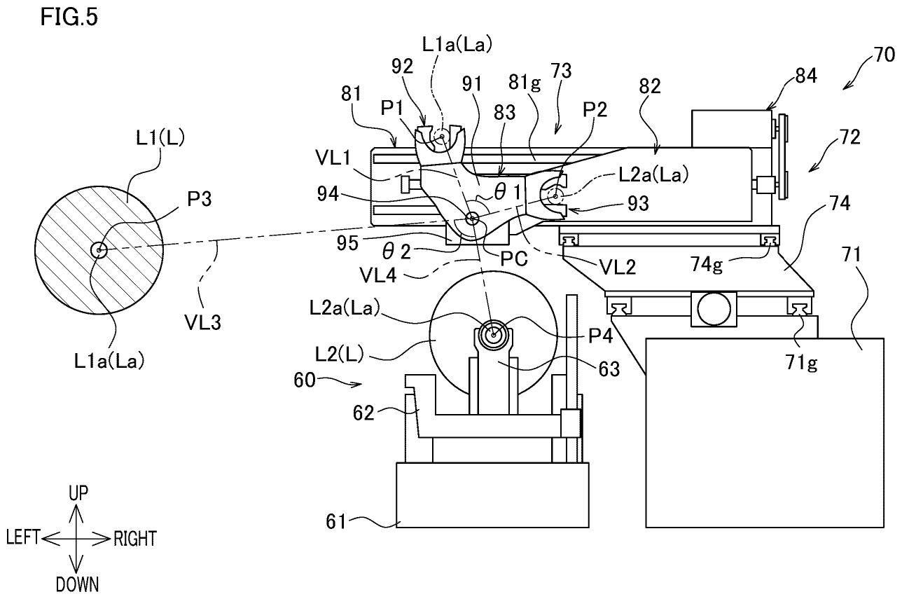

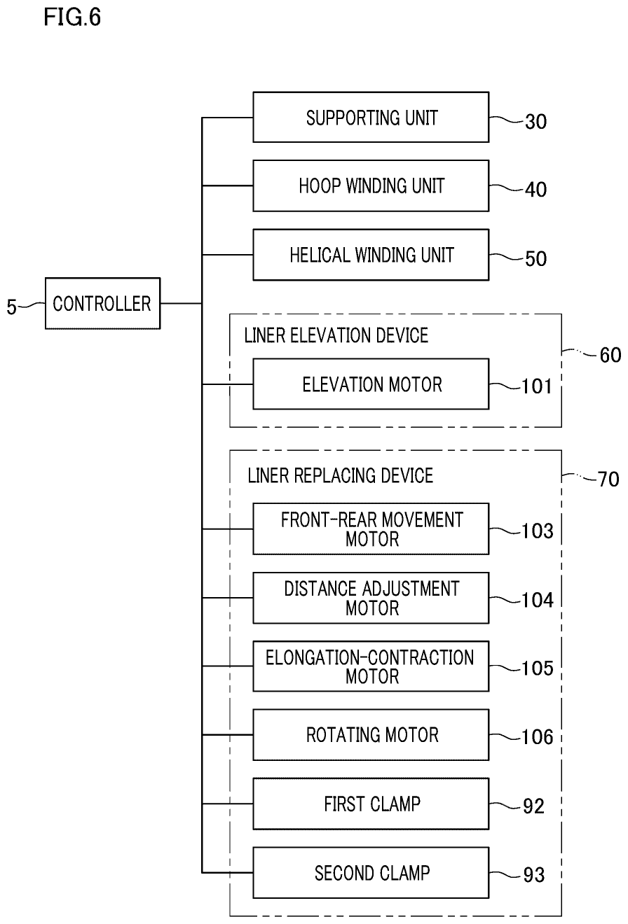

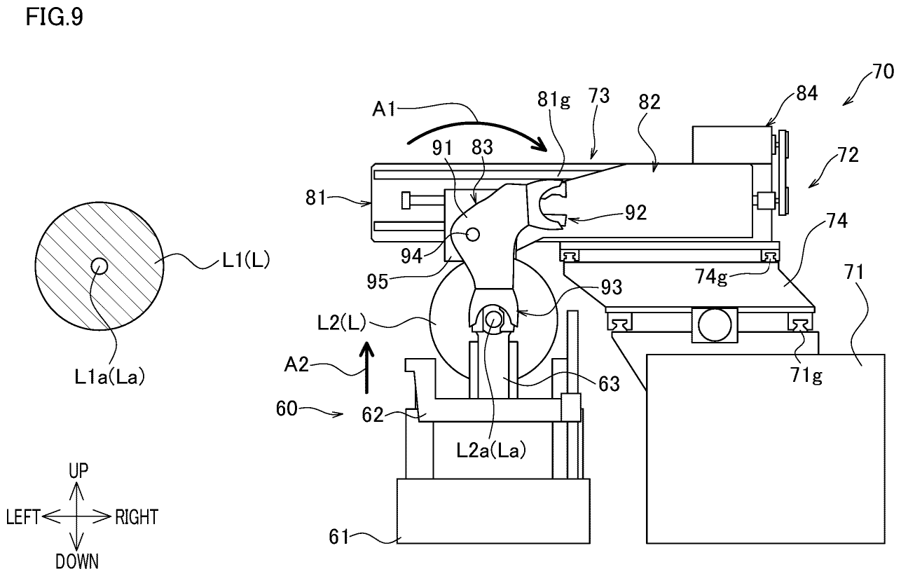

The following will describe an example of a more detailed configuration of the liner elevation device 60, with reference to FIG. 4 to FIG. 6. FIG. 5 is a front view of the liner elevation device 60 and the liner replacing device 70. FIG. 6 is a block diagram showing a detailed electrical structure of the filament winding device 1. FIG. 5 shows a liner L supported by the supporting unit 30 (in this example, a winding-completed liner L1) in addition to the liner elevation device 60 and the liner replacing device 70. The supporting unit 30 is not shown in FIG. 5. The same applies to FIG. 9 to FIG. 12 that are described later.

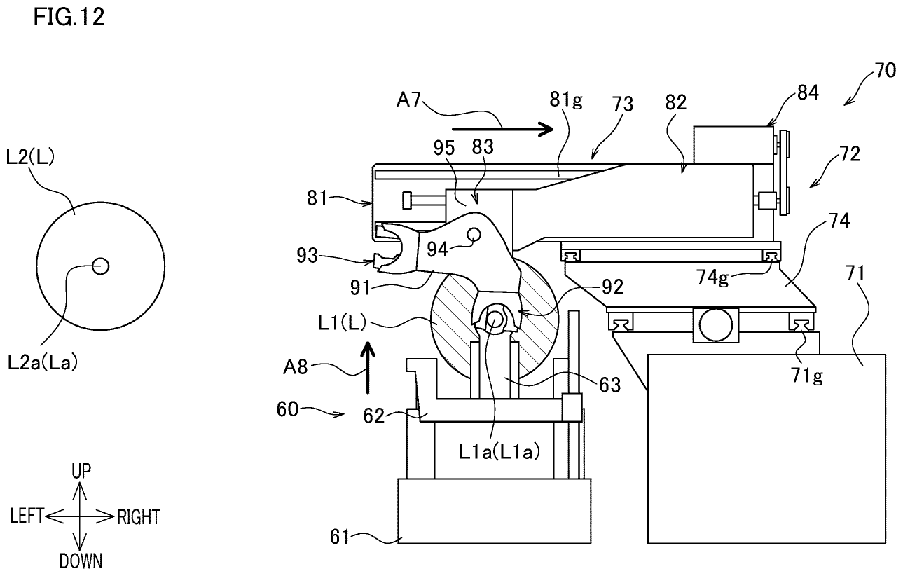

The liner elevation device 60 includes, for example, a base portion 61 and an elevation portion 62 (see FIG. 4 and FIG. 5). The base portion 61, is, for example, positionally fixed in the up-down direction. The elevation portion 62 is configured to be movable in the up-down direction (i.e., able to move up and down) relative to the base portion 61 by, for example, an unillustrated ball screw mechanism. The driving source of the ball screw mechanism is, for example, an elevation motor 101 (see FIG. 6). The mechanism and the driving source for elevating the elevation portion 62 are not limited to the above-described ones. The elevation portion 62 is provided with paired supporting portions 63 that are arranged to be able to support the paired shafts La of the liner L. Each of the supporting portions 63 is, for example, a plate-shaped member provided at an upper end portion of the elevation portion 62. The upper end portion of each supporting portion 63 is substantially Y-shaped when viewed in the front-rear direction, for example. The paired supporting portions 63 are aligned in the front-rear direction and extend in the up-down direction, for example. This allows the paired shafts La to be mounted on the supporting portions 63. The elevation portion 62 is capable of moving up and down between a predetermined reference position (see FIG. 5) and a lifted position above the reference position (see FIG. 9 and FIG. 12), for example.

### Liner Replacing Device

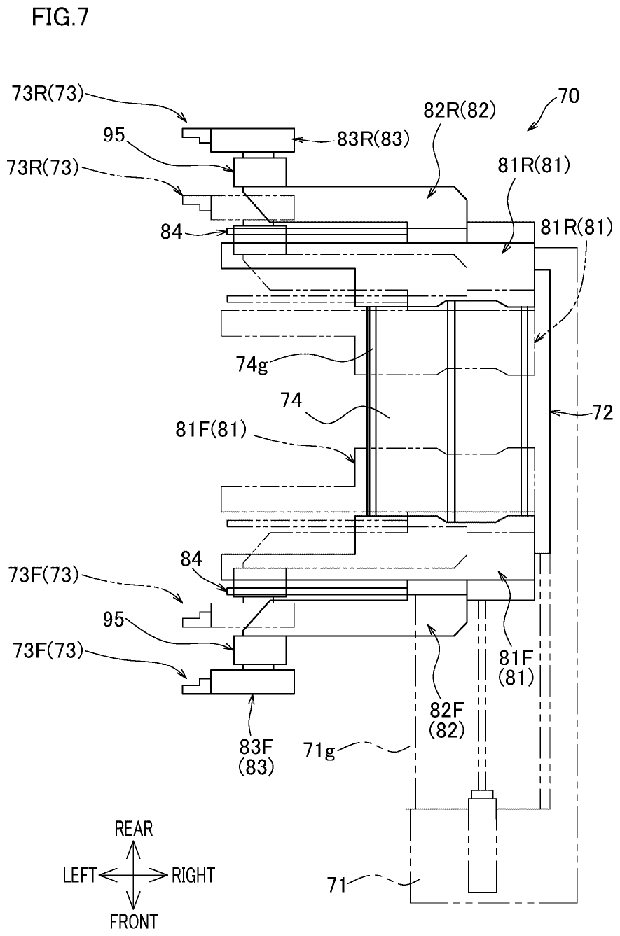

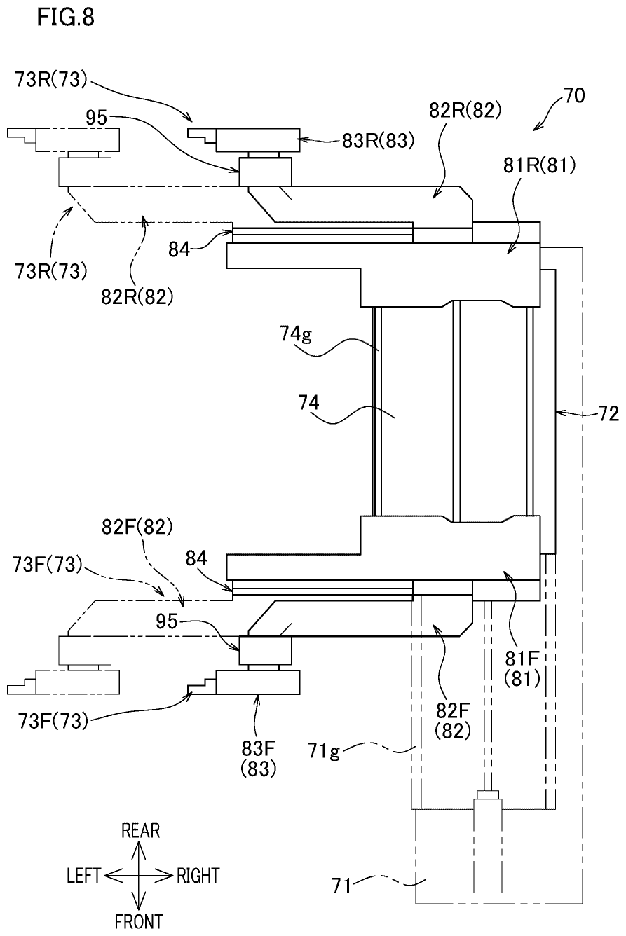

The following will describe an example of a more detailed configuration of the liner replacing device 70, with reference to FIG. 4 to FIG. 8. FIG. 7 and FIG. 8 are plan views of the liner replacing device 70.

As described above, the liner replacing device 70 has, for example, the base portion 71, the front-rear movement portion 72, and the paired arm portions 73 (see FIG. 4 and FIG. 5). The base portion 71 has, for example, a guide rail 71g extending in the front-rear direction. The front-rear movement portion 72 is configured to change the position of the entirety of the paired arm portions 73 in the front-rear direction. The front-rear movement portion 72 is arranged to be movable in the front-rear direction along the guide rail 71g. The front-rear movement portion 72 is moved by an unillustrated ball screw mechanism, for example. The driving source of the ball screw mechanism is, for example, a front-rear movement motor 103 (see FIG. 4 and FIG. 6). The front-rear movement motor 103 is, e.g., a typical stepping motor. The front-rear movement motor 103 is controlled by the controller 5. The driving mechanism and the driving source of the front-rear movement portion 72 are not limited to those described above. The front-rear movement portion 72 has a supporting member 74 supporting the paired arm portions 73. The supporting member 74 has, for example, a guide rail 74g extending in the front-rear direction (see FIG. 4 and FIG. 5). The guide rail 74g is configured to be able to guide the paired arm portions 73 in the front-rear direction.

The paired arm portions 73 (arm portions 73F and 73R) are, as described later, configured to be able to grip two liners L and move the two liners L. Each of the paired arm portions 73 is configured to perform, as more specific operations, a movement operation in the front-rear direction, an elongation-contraction operation, rotation of a gripping jig 83 (described later), and an opening-closing operation of clamps (described later; no reference number is shown here). Each of the paired arm portions 73 extends, for example, in the left-right direction (predetermined direction). The paired arm portions 73 are aligned, for example, in the front-rear direction. The arm portion 73F is positioned on the front side, whereas the arm portion 73R is positioned on the rear side.

As shown in FIG. 7 and FIG. 8, the paired arm portions 73 include paired distance adjustment portions 81, paired telescopic portions 82, and paired gripping jigs 83. Each arm portion 73 has one distance adjustment portion 81, one telescopic portion 82, and one gripping jig 83. The arm portion 73F and the arm portion 73R are provided in a substantially symmetrical manner in the front-rear direction, for example. A sign “F” is appended to the end of the reference number of each constituent feature included in the arm portion 73F as appropriate. On the other hand, a sign “R” is appended to the end of the reference number of each constituent feature included in the arm portion 73R as appropriate.

The paired distance adjustment portions 81 (distance adjustment portions 81F and 81R) are arranged so that the distance between the paired gripping jigs 83 is adjustable in the front-rear direction (the up-down direction in the sheet of each of FIG. 7 and FIG. 8) in accordance with the length in the front-rear direction of the liner L. The paired distance adjustment portions 81 are provided on the guide rail 74g and are arranged to be movable in the front-rear direction along the guide rail 74g. Each distance adjustment portion 81 is positionally fixed in the left-right direction. Each distance adjustment portion 81 moves in the front-rear direction together with the telescopic portion 82 and the gripping jig 83 (see the solid lines and two-dot chain lines in FIG. 7). The paired distance adjustment portions 81 are moved by an unillustrated rack-and-pinion mechanism, for example. The driving source of the rack-and-pinion mechanism is, for example, a distance adjustment motor 104 (see FIG. 6). The distance adjustment motor 104 is, e.g., a known stepping motor. The distance adjustment motor 104 is controlled by the controller 5. The paired distance adjustment portions 81 are moved toward each other and away from each other in the front-rear direction (see the solid lines and two-dot chain lines in FIG. 7). In the present example, both of the distance adjustment portions 81F and 81R are simultaneously moved by one distance adjustment motor 104. However, the disclosure is not limited to this. A driving source (not illustrated) may be independently provided to move each of the distance adjustment portions 81F and 81R. Alternatively, only one of the distance adjustment portions 81F and 81R may be movable in the front-rear direction. The driving mechanism and the driving source of the paired distance adjustment portions 81 are not limited to those described above.

Each distance adjustment portion 81 extends, for example, in the left-right direction and supports the telescopic portion 82 and the gripping jig 83 to be movable in the left-right direction. Each distance adjustment portion 81 includes, for example, a guide rail 81g. The guide rail 81g extends, for example, in the left-right direction and is arranged to be able to guide the telescopic portion 82.

The paired telescopic portions 82 (telescopic portions 82F and 82R) are provided to extend and contract the paired arm portions 73 in, for example, the left-right direction (i.e., the left-right direction in the sheet of each of FIG. 7 and FIG. 8). The telescopic portion 82F is provided on the front side of the distance adjustment portion 81F. The telescopic portion 82R is provided on the rear side of the distance adjustment portion 81R. In other words, the paired telescopic portions 82 are provided on the outer sides of the paired distance adjustment portions 81 in the front-rear direction. The paired telescopic portions 82 are supported by the respective distance adjustment portions 81 to be movable. The telescopic portion 82 is guided in the left-right direction along the guide rail 81g. At a leading end portion (left end portion in the present example) of each telescopic portion 82, the gripping jig 83 is attached, for example. Each telescopic portion 82 supports the gripping jig 83 to be rotatable, through a later-described rotational drive unit 95.

Each telescopic portion 82 is moved by, for example, a ball screw mechanism 84 (movement drive unit; see FIG. 7 and FIG. 8). The driving source of the ball screw mechanism 84 is, for example, an elongation-contraction motor 105 (see FIG. 6). The elongation-contraction motor 105 is, for example, a known stepping motor. The elongation-contraction motor 105 is controlled by the controller 5. While FIG. 6 shows only one elongation-contraction motor 105, in the present example, one elongation-contraction motor 105 is provided for each telescopic portion 82, for example. This allows the paired gripping jigs 83 to move in a parallel manner in the left-right direction with respect to the supporting unit 30. Each telescopic portion 82 is movable together with the gripping jig 83 in the left-right direction. Each telescopic portion 82 is movable between a predetermined standby position and an extended position that is close to the supporting unit 30 in the left-right direction compared to the standby position (see solid and two-dot chain lines in FIG. 8). The driving mechanism and the driving source of the telescopic portion 82 are not limited to those described above.

The paired gripping jigs 83 (gripping jigs 83F and 83R) are used to grip two liners L. As shown in FIG. 7 and FIG. 8, the gripping jig 83F is positioned on the front side of the telescopic portion 82F. The gripping jig 83R is positioned on the rear side of the telescopic portion 82R. In other words, the paired gripping jigs 83 are provided on the outer sides of the paired telescopic portions 82 in the front-rear direction. The gripping jig 83F and the gripping jig 83R are provided in a substantially symmetrical manner in the front-rear direction, for example. The paired gripping jigs 83 are positionally adjusted by the paired distance adjustment portions 81 and the paired telescopic portions 82. The paired gripping jigs 83 can be moved, by the paired telescopic portions 82, in the left-right direction toward and away from the liner L supported by the supporting unit 30. As shown in FIG. 5, each gripping jig 83 includes a rotatable component 91, a first clamp 92, and a second clamp 93. FIG. 5 shows only the rotatable component 91, the first clamp 92, and the second clamp 93 of the gripping jig 83 (gripping jig 83F) on the front side. Although not illustrated, the gripping jig 83 (gripping jig 83R) on the rear side includes a rotatable component 91, a first clamp 92, and a second clamp 93 in the same manner as the gripping jig 83 on the front side.

The rotatable component 91 is, for example, a substantially L-shaped plate member. In other words, the rotatable component 91 includes, for example, one base end portion and two leading end portions. The rotatable component 91 is rotatably attached to a leading end portion (left end portion in the present example) of the telescopic portion 82 through a rotation shaft 94. The rotation shaft 94 is, for example, fixed to the base end portion of the rotatable component 91. The rotation shaft 94 extends in the front-rear direction, for example. For convenience of explanation, the center point of the rotation shaft 94 when the paired gripping jigs 83 are viewed in the front-rear direction is referred to as a point PC (see FIG. 5). The rotatable component 91 is rotated by, for example, a rotational drive unit 95. The rotational drive unit 95 is attached to the telescopic portion 82. The driving source of the rotational drive unit 95 is, for example, a rotating motor 106. The rotating motor 106 is, for example, a known stepping motor. The rotating motor 106 is controlled by the controller 5.

The first clamp 92 is a known clamp device capable of gripping the liner L. More specifically, the first clamp 92 is provided to grip the winding-completed liner L1. The first clamp 92 is a known air clamp that operates, for example, with compressed air. The first clamp 92 includes a solenoid valve (not illustrated) for controlling the supply and discharge of compressed air. The solenoid valve is controlled by the controller 5. The first clamp 92 is attached to one of the two leading end portions of the rotatable component 91, for example. The first clamp 92 is rotatable together with the rotatable component 91. For convenience of explanation, the center point of the winding-completed liner L1 when the paired gripping jigs 83 are viewed in the front-rear direction and it is assumed that the shaft L1a of the winding-completed liner L1 is gripped by the first clamp 92 is referred to as a point P1 (see FIG. 5). For convenience of explanation, a virtual line segment connecting the point PC and the point P1 will be referred to as a first virtual line segment VL1 (see FIG. 5).

The second clamp 93 is a known clamp device capable of gripping the liner L. More specifically, the second clamp 93 is provided to grip the new liner L2. The second clamp 93 is a known air clamp that operates, for example, with compressed air. The second clamp 93 includes a solenoid valve (not illustrated) for controlling the supply and discharge of compressed air. The solenoid valve is controlled by the controller 5. The second clamp 93 is attached to the other of the two leading end portions of the rotatable component 91, for example. The second clamp 93 is rotatable together with the rotatable component 91. For convenience of explanation, the center point of the new liner L2 when the paired gripping jigs 83 are viewed in the front-rear direction and it is assumed that the shaft L2a of the new liner L2 is gripped by the second clamp 93 is referred to as a point P2 (see FIG. 5). For convenience of explanation, a virtual line segment connecting the point PC and the point P2 will be referred to as a second virtual line segment VL2 (see FIG. 5). The length of the first virtual line segment VL1 and the length of the second virtual line segment VL2 are substantially identical, for example. When the angle between the first virtual line segment VL1 and the second virtual line segment VL2 is an angle θ1, the angle θ1 is smaller than 180 degrees, for example.

A specific positional relationship between the first clamp 92 and the second clamp 93 will be described with reference to FIG. 5. For convenience of explanation, the center point of a liner L when the liner L is viewed from the front side and it is assumed that the liner L is supported by the supporting unit 30 is referred to as a point P3. For convenience of explanation, a virtual line segment connecting the point PC and the point P3 will be referred to as a third virtual line segment VL3. For convenience of explanation, the center point of a liner L when the liner L is viewed in the front-rear direction and it is assumed that the liner L is supported by the liner elevation device 60 is referred to as a point P4. For convenience of explanation, a virtual line segment connecting the point PC and the point P4 will be referred to as a fourth virtual line segment VL4. In the present example, when viewed from the front, the fourth virtual line segment VL4 overlaps the third virtual line segment VL3 after the fourth virtual line segment VL4 is rotated clockwise about the point PC by a predetermined angle θ2 that is less than 180 degrees. Furthermore, in the present example, when viewed from the front, the first virtual line segment VL1 overlaps the second virtual line segment VL2 after the first virtual line segment VL1 is rotated clockwise about the point PC by an angle θ1. The positional relationship between the first clamp 92 and the second clamp 93 is arranged in this manner.

### Operation Control of Liner Replacing Device

The following will describe how the liner replacing device 70 replaces a liner L with reference to FIG. 5 and FIG. 9 to FIG. 12. FIGS. 9 to 12 show the operations of the liner replacing device 70. Being similar to FIG. 5, each of FIG. 9 to FIG. 12 is a front view of the liner elevation device 60 and the liner replacing device 70. The controller 5 (control unit) controls the liner elevation device 60 and the liner replacing device 70. For the sake of simplicity, it is assumed that the front-rear movement portion 72 of the liner replacing device 70 has been moved to a position that is substantially identical in the front-rear direction with the position of the elevation portion 62 of the liner elevation device 60. It is also assumed that the positions in the front-rear direction of the paired distance adjustment portions 81 have been suitably adjusted in accordance with the position in the front-rear direction of the liner L. The following will only describe operations when the members such as the liner replacing device 70 are viewed from the front side, and explanations related to the movement of the front-rear movement portion 72 and the paired distance adjustment portions 81 in the front-rear direction are omitted. Furthermore, the explanation presupposes that the paired arm portions 73 (arm portions 73F and 73R) are substantially simultaneously controlled by the controller 5. To easily distinguish a winding-completed liner L1 from a new liner L2 in FIG. 5 and FIG. 9 to FIG. 12, the winding-completed liner L1 is hatched in FIG. 5 and FIG. 9 to FIG. 12.

An initial state of the liner elevation device 60 and the liner replacing device 70 is as shown in FIG. 5, for example. In the initial state, the first clamp 92 is positioned above the rotation shaft 94, for example. The second clamp 93 is positioned to the right of the rotation shaft 94, for example. This position of the rotatable component 91 is termed an initial position. In the initial state, the winding-completed liner L1 is supported by the supporting unit 30. The new liner L2 is supported by the supporting portions 63 of the liner elevation device 60. The elevation portion 62 of the liner elevation device 60 is located at the reference position. The telescopic portion 82 of the liner replacing device 70 is located at the standby position.

To begin with, the controller 5 controls the rotating motor 106 (see FIG. 6) to rotate the rotatable component 91 at the initial position. As a result, the controller 5 moves the second clamp 93 to a position directly above the shaft L2a of the new liner L2 (see FIG. 9). In other words, the controller 5 causes the second clamp 93 to oppose the shaft L2a in the up-down direction. In the present example, the controller 5 rotates the rotatable component 91, e.g., clockwise when viewed from the front side (see an arrow A1 in FIG. 9). Subsequently, the controller 5 controls the elevation motor 101 (see FIG. 6) to move the elevation portion 62 from the reference position to the lifted position (see an arrow A2 in FIG. 9). The controller 5 then causes the second clamp 93 to grip the shaft L2a.

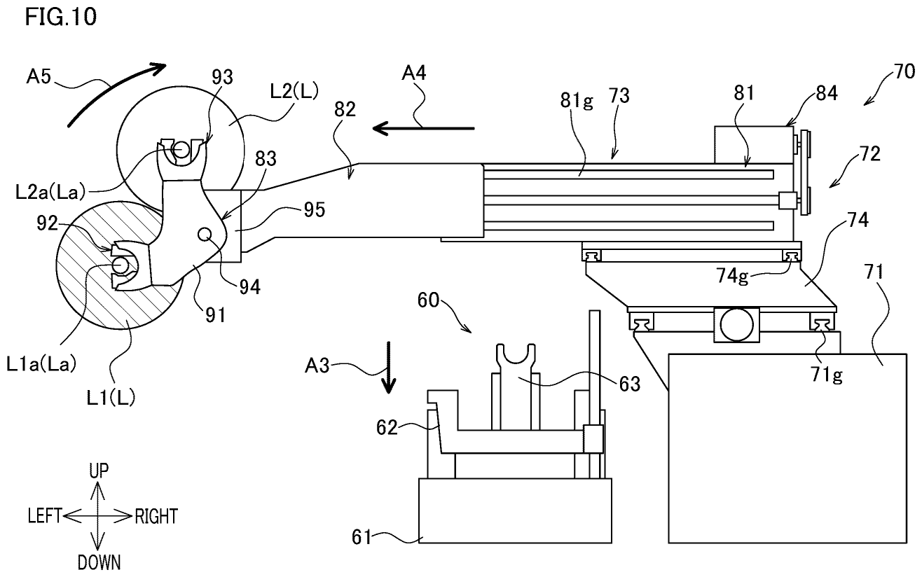

Subsequently, the controller 5 controls the elevation motor 101 (see FIG. 6) to move the elevation portion 62 from the lifted position to the reference position (see an arrow A3 in FIG. 10). At this stage, the state in which the shaft L2a is gripped by the second clamp 93 is maintained. Subsequently, while moving the telescopic portion 82 leftward (see an arrow A4 in FIG. 10) by controlling the elongation-contraction motor 105 (see FIG. 6), the controller 5 controls the rotating motor 106 (see FIG. 6) to rotate the rotatable component 91 clockwise for about 180 degrees (see an arrow A5 in FIG. 10). More specifically, the controller 5 controls the elongation-contraction motor 105 and the rotating motor 106 simultaneously so that the new liner L2 moves to a position above the winding-completed liner L1 without interfering with any of the distance adjustment portion 81, the telescopic portion 82, and the winding-completed liner L1. The controller 5 moves the new liner L2 to a position above the winding-completed liner L1 and moves the first clamp 92 to a position just beside the shaft L1a of the winding-completed liner L1. Furthermore, the controller 5 controls the elongation-contraction motor 105 to move the first clamp 92 to a position where the first clamp 92 is able to grip the shaft L1a (the above-described extended position). Then the controller 5 causes the first clamp 92 to grip the shaft L1a.

Subsequently, the controller 5 controls the supporting unit 30 (see FIG. 4) to release the paired shafts L1a of the winding-completed liner L1 from the chucking portion 37 and the chucking portion 39. The controller 5 then moves the supporting unit 30 away from the paired shafts L1a in the front-rear direction. At this stage, the state in which the shaft L1a is gripped by the first clamp 92 is maintained. The state in which the shaft L2a is gripped by the second clamp 93 is maintained, too. In this way, the winding-completed liner L1 and the new liner L2 are simultaneously gripped by the paired gripping jigs 83.

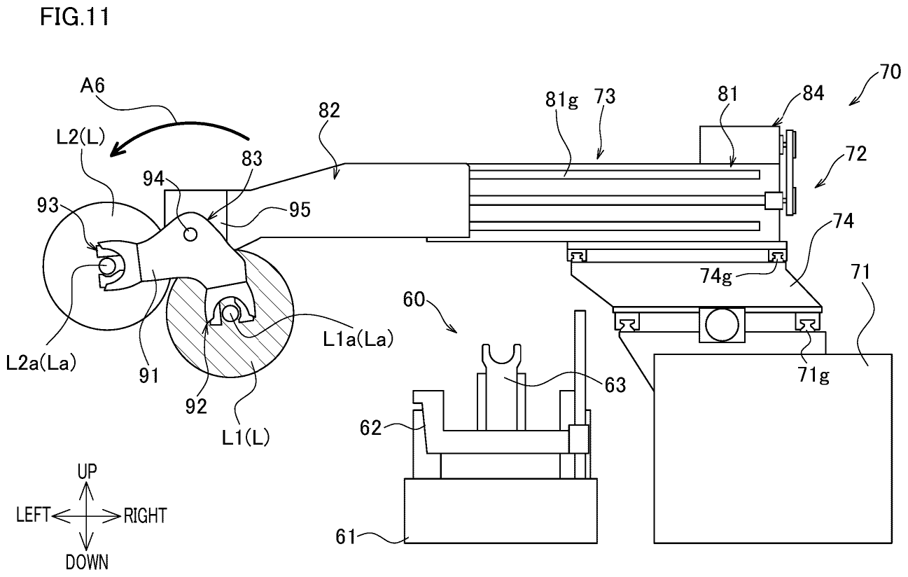

Subsequently, the controller 5 controls the rotating motor 106 (see FIG. 6) to rotate the rotatable component 91 counterclockwise (see an arrow A6 in FIG. 11). The rotation angle is, for example, the above-described angle θ1 (see FIG. 5). As a result, the winding-completed liner L1 moves away from the supporting unit 30, while the new liner L2 moves toward the supporting unit 30. In other words, the winding-completed liner L1 and the new liner L2 are moved simultaneously. While the liners are moving, the controller 5 controls the rotating motor 106 to position the winding-completed liner L1 to be always below the new liner L2. In other words, there is no need to lift the winding-completed liner L1, which has been increased in weight due to the fiber bundle F wound thereon, to a high position against gravity. Then the controller 5 causes the supporting unit 30 (see FIG. 4) to support the paired shafts L2a of the new liner L2. As a result, it becomes possible to release the shaft L2a from the second clamp 93. The controller 5 causes the second clamp 93 to release the shaft L2a.

Subsequently, the controller 5 controls the elongation-contraction motor 105 (see FIG. 6) to move the telescopic portion 82 from the extended position to the standby position (see an arrow A7 in FIG. 12). While the telescopic portion 82 is moving, the winder 2 may start the winding of a fiber bundle F onto the new liner L2. Subsequently, the controller 5 controls the elevation motor 101 (see FIG. 6) to move the elevation portion 62 from the reference position to the lifted position (see an arrow A8 in FIG. 12). The controller 5 then causes the first clamp 92 to release the shaft L1a. Finally, the controller 5 returns the rotatable component 91 to the initial position and returns the elevation portion 62 from the lifted position to the reference position. With this operation, the replacement of the winding-completed liner L1 with the new liner L2 is completed.

As described above, the winding-completed liner L1 and the new liner L2 can be simultaneously gripped by the paired gripping jigs 83. On this account, the winding-completed liner L1 and the new liner L2 can be moved simultaneously, according to need. Therefore, the time required for replacing the liner L can be shortened.

In addition to the above, the liner replacing device 70 is provided with a rotational drive unit 95. With this arrangement, the liner L can be moved in a narrow moving space compared to when the paired gripping jigs 83 can perform only parallel movement.

In addition to the above, the angle (θ1) formed between the first virtual line segment VL1 and the second virtual line segment VL2 is less than 180 degrees. This makes it possible to minimize the distance between the two liners L that are simultaneously gripped by the liner replacing device 70. With this arrangement, the moving distance of the new liner L2 is minimized when the winding-completed liner L1 is detached from the supporting unit 30 and the new liner L2 is attached to the supporting unit 30. The time required for replacing the liner L can therefore be shortened.

In addition to the above, the controller 5 controls the rotational drive unit 95 so that the first clamp 92 gripping the winding-completed liner L1 is always below the second clamp 93 gripping the new liner L2. It is therefore possible to maximally avoid the necessity of lifting of the winding-completed liner L1, which has been increased in weight due to the fiber bundle F wound thereon, to a high position against gravity. The load on the rotational drive unit 95 can therefore be reduced.

The controller 5 controls the ball screw mechanism 84 to move the paired gripping jigs 83, and at the same time controls the rotational drive unit 95 to rotate the paired gripping jigs 83. Therefore, the time required for replacing the liner L can be shortened compared to when the parallel movement and the rotation of the paired gripping jigs 83 are performed at different timings.

The following will describe modifications of the above-described example. The members identical with those in the example above will be denoted by the same reference numerals and the explanations thereof may not be repeated.

(1) In the example above, the controller 5 controls the ball screw mechanism 84 to move the paired gripping jigs 83, and at the same time controls the rotational drive unit 95 to rotate the paired gripping jigs 83. However, the disclosure is not limited to this. The controller 5 may control the ball screw mechanism 84 and the rotational drive unit 95 at different timings.

(2) In the example above, the controller 5 controls the rotational drive unit 95 so that the first clamp 92 gripping the winding-completed liner L1 is always below the second clamp 93 gripping the new liner L2. However, the disclosure is not limited to this. The controller 5 may move the first clamp 92 gripping the winding-completed liner L1 to a position above the second clamp 93 gripping the new liner L2.

(3) In the example above, the angle formed between the first virtual line segment VL1 and the second virtual line segment VL2 is less than 180 degrees. However, the disclosure is not limited to this. The angle may be 180 degrees. In this example, however, the control, and the like is required to be suitably modified to prevent the liner L from interfering with the paired arm portions 73.

(4) In the example above, the rotatable component 91 of the gripping jig 83 is substantially L-shaped. However, the shape of the rotatable component 91 is not limited to this. The rotatable component 91 may have a shape such as a rod-like shape or a disc-like shape, for example.

(5) In the example above, the liner replacing device 70 is provided with the rotational drive unit 95. However, the disclosure is not limited to this. The liner replacing device 70 may be configured to cause the paired gripping jigs 83 to perform only parallel movement.

(6) In the example above, the paired gripping jigs 83 are provided on the outer sides of the paired telescopic portions 82 and the paired distance adjustment portions 81 in the front-rear direction. However, the disclosure is not limited to this. The paired gripping jigs 83 may be provided on the inner sides of the paired telescopic portions 82 and the paired distance adjustment portions 81 in the front-rear direction.

(7) In the example above, the paired arm portions 73 have the paired distance adjustment portions 81 capable of moving relative to each other in the front-rear direction. However, the disclosure is not limited to this. The distance between the paired arm portions 73 may be fixed in the front-rear direction.

(8) In the example above, the liner replacing device 70 has the paired arm portions 73 capable of extending and contracting in the left-right direction. However, the disclosure is not limited to this. The entire liner replacing device 70 may be configured to be movable in the left-right direction, for example. It is also possible to move the paired gripping jigs 83 in the left-right direction.

(9) In the example above, the liner elevation device 60 is configured to move up and down the liner L. However, the disclosure is not limited to this. In place of the liner elevation device 60, a mounting portion (not illustrated) on which the liner L is simply mounted may be provided. For example, the liner replacing device 70 may be configured to move the paired gripping jigs 83 up and down relative to the mounting portion.

(10) In the example above, the front-rear direction is equivalent to the liner axial direction. However, the disclosure is not limited to this. The liner axial direction may be tilted relative to the front-rear direction, on condition that the liner axial direction has a horizontal component.

What is claimed is:

1. A liner replacing device configured to replace a liner for a supporter that supports the liner in a filament winding device that winds a fiber bundle onto the liner,
the liner replacing device comprising paired gripping jigs which are aligned in a predetermined liner axial direction having a horizontal component and are configured to move toward and away from the supporter in a predetermined direction orthogonal to both the liner axial direction and an up-down direction,
wherein each of the paired gripping jigs includes: a first clamp configured to grip a first liner that is the liner and on which the fiber bundle is wound; and a second clamp configured to grip a second liner that is the liner and on which the fiber bundle has not been wound.

2. The liner replacing device according to claim 1, further comprising a rotational drive unit which is configured to rotationally drive the paired gripping jigs about a rotation shaft extending in the liner axial direction.

3. The liner replacing device according to claim 2, wherein,
when viewed in the liner axial direction,
an angle between a first virtual line segment and a second virtual line segment is smaller than 180 degrees, the first virtual line segment connecting the center point of the rotation shaft and the center point of the first liner when the first liner is gripped by the first clamp, and
the second virtual line segment connecting the center point of the rotation shaft and the center point of the second liner when the second liner is gripped by the second clamp.

4. The liner replacing device according to claim 2, further comprising a control unit,
wherein the control unit controls the rotational drive unit to position the first clamp gripping the first liner to be always below the second clamp gripping the second liner.

5. The liner replacing device according to claim 2, further comprising:
a movement drive unit which is configured to move the paired gripping jigs in the predetermined direction; and
a control unit,
wherein the control unit controls the rotational drive unit to rotate the paired gripping jigs, while moving the paired gripping jigs in the predetermined direction by controlling the movement drive unit.
